(19) United States
(12) Patent Application Publication
(10) Pub. No.: US 2026/0299243 A1
(43) Pub. Date: Oct. 1, 2026

(54) OPTICAL WIRING COMPONENT, OPTICAL WIRING UNIT, OPTICAL WIRING MODULE, AND OPTICAL FIBER-WIRING METHOD

(71) Applicant: Fujikura Ltd., Tokyo (JP)

(72) Inventors: Ryoichi Mitobe, Sakura-shi (JP); Shigeo Takahashi, Sakura-shi (JP)

(73) Assignee: Fujikura Ltd., Tokyo (JP)

(21) Appl. No.: 19/633,405

(22) Filed: Mar. 30, 2026

(30) Foreign Application Priority Data
Mar. 31, 2025 (JP) 2025-057580

(51) Int. Cl. G02B 6/44

(52) U.S. Cl. CPC G02B 6/44528

(57) ABSTRACT

An optical wiring component includes: an inlet portion including inlet hole groups, each of the inlet hole groups including inlet holes; an outlet portion including outlet holes; and a joining portion connected to each of the outlet holes and the inlet holes.

### TECHNICAL FIELD

The present disclosure relates to an optical wiring component, an optical wiring unit, an optical wiring module, and an optical fiber-wiring method.

Priority is claimed on Japanese Patent Application No. 2025-057580, filed on Mar. 31, 2025, the content of which is incorporated herein by reference.

### BACKGROUND

Japanese Unexamined Patent Application, First Publication No. 2002-148449 discloses a structure of holding a state in which a plurality of optical fibers are wired by stacking a plurality of sheets.

More specifically, an adhesive is provided between the sheets, and the sheets are bonded to each other while wiring portions of the optical fibers are fixed to the sheets by the adhesive.

In a case where a plurality of sheets are bonded together in order to hold wiring of optical fibers, various issues arise. For example, air may enter between the sheets, and the air may expand or contract due to temperature changes to cause lateral pressure to act on the optical fibers. Alternatively, at a location where the optical fibers intersect with each other, the optical fibers may be pressed by the sheet, and local bending or lateral pressure may act thereon. Such lateral pressure or bending may cause an increase in transmission loss or breaking in the optical fibers. In addition, in a case where the wiring is complicated, it is difficult to perform work on a flat surface, and it is also difficult to bond the sheets together while maintaining the wiring state.

### SUMMARY

One or more embodiments of the invention alleviate various issues caused by bonding a plurality of sheets together in order to hold wiring of optical fibers.

An optical wiring component according to a first aspect of the present disclosure includes an inlet portion in which a plurality of inlet hole groups are formed; and an outlet portion in which a plurality of outlet holes are formed, in which each of the plurality of inlet hole groups includes a plurality of inlet holes, a joining portion is connected to each of the plurality of outlet holes, and the joining portion is connected to the plurality of inlet holes.

An optical wiring unit according to a second aspect of the present disclosure includes the optical wiring component according to the first aspect; and a plurality of optical fibers inserted from the plurality of inlet holes in the plurality of inlet hole groups to the plurality of outlet holes.

A third aspect of the present disclosure is that in the optical wiring unit according to the first or second aspect, a curvature radius of a bent portion in a wiring path from the plurality of inlet holes in the plurality of inlet hole groups to the plurality of outlet holes is greater than an allowable bending radius of the plurality of optical fibers.

A fourth aspect of the present disclosure is that the optical wiring unit according to the second or third aspect further includes a plurality of upstream connectors connected to the plurality of optical fibers extending from the plurality of inlet holes in the plurality of inlet hole groups; and a plurality of downstream connectors connected to the plurality of optical fibers extending from the plurality of outlet holes.

An optical wiring module according to a fifth aspect of the present disclosure includes the optical wiring unit according to the fourth aspect; a plurality of upstream adapters into which the plurality of upstream connectors are inserted; a plurality of downstream adapters into which the plurality of downstream connectors are inserted; and a housing supporting the plurality of upstream adapters and the plurality of downstream adapters.

A sixth aspect of the present disclosure is that the optical wiring component according to the first aspect further includes a block body including a first end surface serving as the inlet portion and a second end surface serving as the outlet portion, in which a plurality of tubular wiring paths connecting the plurality of inlet hole groups and the plurality of outlet holes are formed inside the block body.

An optical fiber-wiring method according to a seventh aspect of the present disclosure includes preparing an optical wiring component including a plurality of inlet hole groups and a plurality of outlet holes, and a plurality of optical fibers; inserting the plurality of optical fibers into the optical wiring component through a plurality of inlet holes included in each of the plurality of inlet hole groups; joining the plurality of optical fibers inserted from the plurality of inlet holes at a joining portion inside the optical wiring component; and extending the plurality of optical fibers joined at the joining portion from an outlet hole of the plurality of outlet holes located on a downstream side of the joining portion.

According to the above-described aspects of the present disclosure, it is possible to alleviate various issues caused by bonding a plurality of sheets together in order to hold wiring of optical fibers.

### BRIEF DESCRIPTION OF THE DRAWINGS

FIG. 1 is a perspective view of an optical wiring component according to one or more embodiments.

FIG. 2 is a view in the direction of arrow II in FIG. 1.

FIG. 3 is a view in the direction of arrow III in FIG. 1.

FIG. 4 is a schematic view of an optical wiring unit according to one or more embodiments.

FIG. 5 is a perspective view of an optical wiring module according to one or more embodiments.

FIG. 6 is a view in which a module lid is removed from the optical wiring module of FIG. 5.

FIG. 7 is a perspective view of an optical wiring device according to one or more embodiments.

FIG. 8 is a view in which a device lid is removed from the optical wiring device of FIG. 7.

### DETAILED DESCRIPTION

### Optical Wiring Component

Hereinafter, an optical wiring component of one or more embodiments will be described with reference to the drawings.

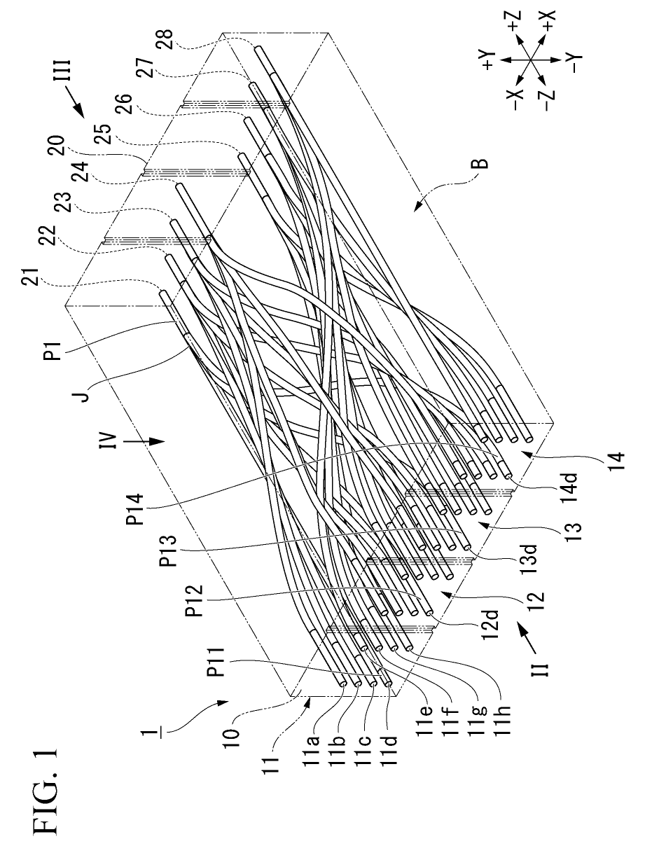

As shown in FIG. 1, an optical wiring component 1 includes an inlet portion 10 and an outlet portion 20. The inlet portion 10 is provided with a first inlet hole group 11, a second inlet hole group 12, a third inlet hole group 13, and a fourth inlet hole group 14. Each of the inlet hole groups 11 to 14 includes a plurality of inlet holes. For example, the first inlet hole group 11 includes eight inlet holes 11a to 11h. Similarly, each of the inlet hole groups 12 to 14 also includes eight inlet holes. The number of inlet hole groups provided in the inlet portion 10 is not limited to four and can be changed. In addition, the number of inlet holes included in each inlet hole group is not limited to eight and can be changed.

The outlet portion 20 is provided with a plurality of outlet holes 21 to 28. In one or more embodiments, the number of outlet holes is eight. The number of outlet holes provided in the outlet portion 20 is not limited to eight and can be changed. The number of outlet holes provided in the outlet portion 20 is less than the total number of inlet holes provided in the inlet portion 10.

### Definition of Direction

In the optical wiring component 1, a direction in which the inlet portion 10 and the outlet portion 20 are arranged is referred to as a longitudinal direction Z. In the longitudinal direction Z, a direction from the inlet portion 10 to the outlet portion 20 (+Z side) is referred to as a downstream side, and a direction from the outlet portion 20 to the inlet portion 10 (-Z side) is referred to as an upstream side. In addition, a direction in which the plurality of inlet hole groups 11 to 14 are arranged in the inlet portion 10 is referred to as a lateral direction X. One side in the lateral direction X will be referred to as a -X side, and the other side will be referred to as a +X side. A direction orthogonal to both the longitudinal direction Z and the lateral direction X will be referred to as an orthogonal direction Y. One side in the orthogonal direction Y is referred to as a -Y side, and the other side is referred to as a +Y side.

The optical wiring component 1 of one or more embodiments has a structure in which a plurality of tubular wiring paths are formed inside a block body B. In the example of FIG. 1, the block body B has a rectangular parallelepiped shape. More specifically, the block body B includes a first end surface facing the upstream side (-Z side) and a second end surface facing the downstream side (+Z side). The first end surface serves as the inlet portion 10, and the second end surface serves as the outlet portion 20. In addition, the block body B includes end surfaces facing the -X side, the +X side, the -Y side, and the +Y side. That is, the block body B includes a total of six end surfaces. However, the shape of the block body B can be changed. In addition, the optical wiring component 1 may have a structure in which, for example, a plurality of tubes are combined instead of the block body B.

The optical wiring component 1 has a structure in which wiring paths extending downstream from a plurality of inlet holes join together inside the optical wiring component 1 and are connected to an outlet hole. In this way, a portion where the wiring paths join together is referred to as a "joining portion J." A plurality of the joining portions J are provided inside the optical wiring component 1. For example, attention will be focused on an inlet hole 11d of the first inlet hole group 11, an inlet hole 12d of the second inlet hole group 12, an inlet hole 13d of the third inlet hole group 13, and an inlet hole 14d of the fourth inlet hole group that are shown in FIG. 1. Wiring paths P11, P12, P13, and P14 extend from the inlet holes 11d, 12d, 13d, and 14d toward the downstream side, respectively. These wiring paths P11, P12, P13, and P14 join together at the joining portion J provided inside the optical wiring component 1. In addition, the joining portion J and the outlet hole 21 are connected to each other through a wiring path P1. The inlet hole groups 11 to 14, the joining portion J, and the outlet holes 21 to 28 are disposed in this order from the downstream side toward the upstream side.

Focusing on the outlet hole 21, the inlet holes 11d, 12d, 13d, and 14d included in the four inlet hole groups 11 to 14, respectively, are connected thereto. Similarly, inlet holes included in the four inlet hole groups 11 to 14 are connected to each of the outlet holes 22 to 28. That is, inlet holes included in the inlet hole groups 11 to 14 are connected to each of all the outlet holes 21 to 28. Therefore, in one or more embodiments, the number of inlet holes is four times the number of outlet holes. Specifically, the number of inlet holes is 32 in total, and the number of outlet holes is 8.

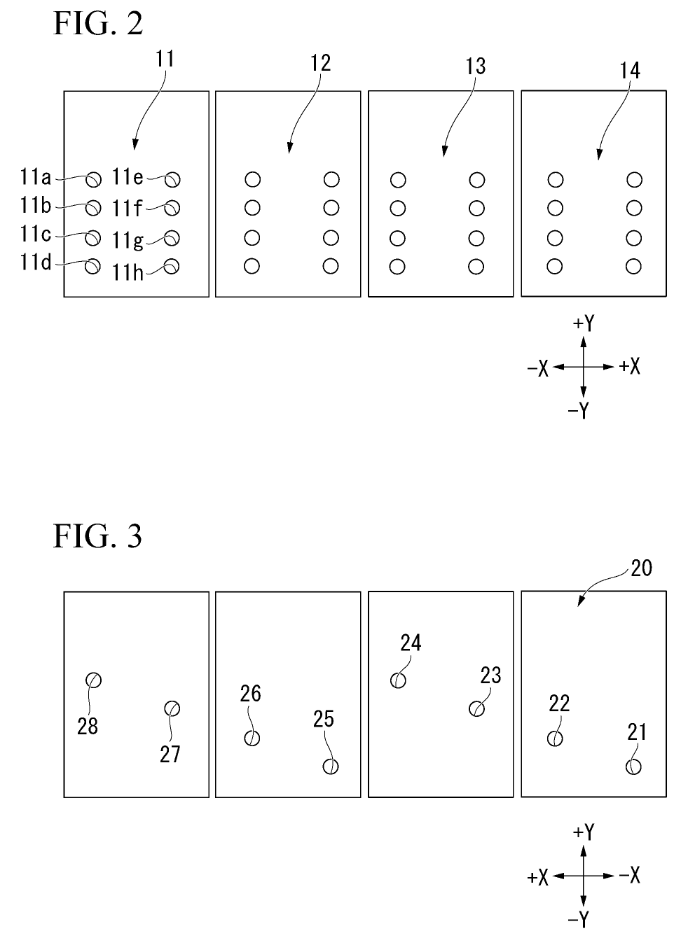

FIG. 2 is a view of the inlet portion 10 in FIG. 1 as viewed in the direction of arrow II. As shown in FIG. 2, when attention is focused on the first inlet hole group 11, the eight inlet holes 11a to 11h are arranged in a 2×4 two-dimensional pattern. Specifically, the four inlet holes 11a to 11d are arranged in a line in the orthogonal direction Y. In addition, the four inlet holes 11e to 11h are arranged in a line in the orthogonal direction Y. The line formed by the inlet holes 11a to 11d and the line formed by the inlet holes 11e to 11h are arranged side by side in the lateral direction X. Similarly, in the other inlet hole groups 12 to 14, the inlet holes are also arranged in a 2×4 two-dimensional pattern.

FIG. 3 is a view of the outlet portion 20 in FIG. 1 as viewed in the direction of arrow III. As shown in FIG. 3, the positions of the outlet holes 21 to 24 are different from each other in the lateral direction X and the orthogonal direction Y. Similarly, the positions of the outlet holes 25 to 28 are different from each other in the lateral direction X and the orthogonal direction Y. In this way, by making the positions of the outlet holes adjacent to each other different in the lateral direction X and the orthogonal direction Y, the wiring paths connected to the outlet holes can be prevented from interfering with each other.

However, the arrangement of the inlet hole groups 11 to 14 and the outlet holes 21 to 28 shown in FIGS. 2 and 3 is merely an example and may be appropriately changed. In addition, in one or more embodiments, inlet holes included in the four inlet hole groups 11 to 14 are connected to each of all the outlet holes 21 to 28. However, the correspondence relationship between the inlet holes and the outlet holes can be changed. For example, a joining portion and an outlet hole to which only some of the four inlet hole groups 11 to 14 are connected may be provided. More specifically, a joining portion and an outlet hole that are connected to only one inlet hole group may be provided.

### Optical Wiring Unit

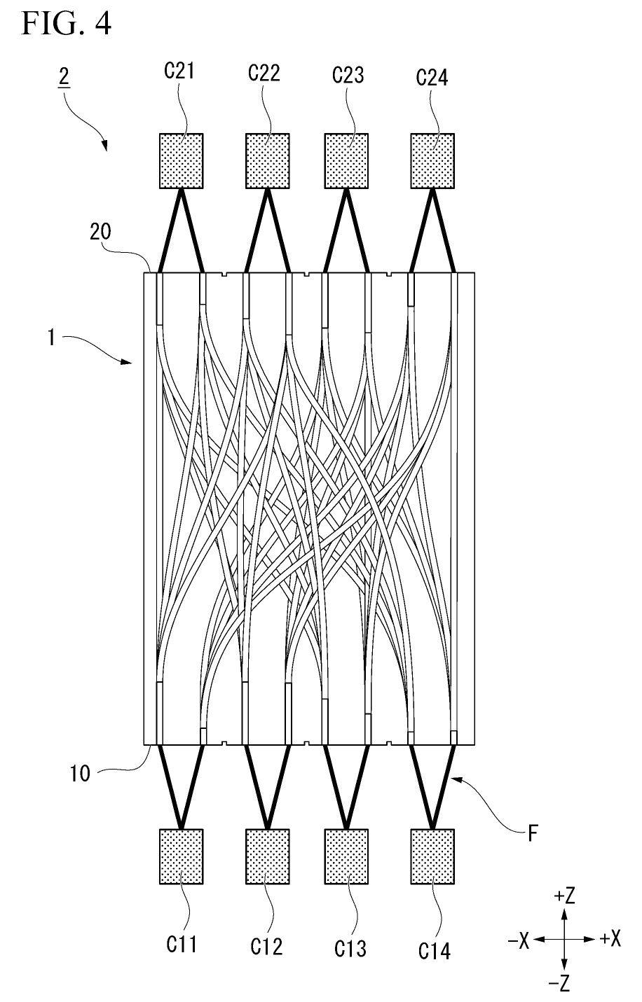

FIG. 4 is a schematic view of an optical wiring unit 2 using the optical wiring component 1. The optical wiring unit 2 includes the optical wiring component 1, a plurality of upstream connectors C11 to C14, a plurality of downstream connectors C21 to C24, and a plurality of optical fibers F. The upstream connectors C11 to C14 correspond to the inlet hole groups 11 to 14 of the optical wiring component 1, respectively. Specifically, the optical fibers F of the first upstream connector C11 are introduced into the optical wiring component 1 through the inlet holes 11a to 11h included in the first inlet hole group 11. Similarly, the optical fibers F of the second upstream connector C12, the third upstream connector C13, and the fourth upstream connector C14 are introduced into the optical wiring component 1 from the inlet holes of the second inlet hole group 12, the inlet holes of the third inlet hole group 13, and the inlet holes of the fourth inlet hole group 14, respectively.

As shown in FIG. 2, the first inlet hole group 11, the second inlet hole group 12, the third inlet hole group 13, and the fourth inlet hole group 14 are arranged in this order from the -X side toward the +X side. Correspondingly, as shown in FIG. 4, the first upstream connector C11, the second upstream connector C12, the third upstream connector C13, and the fourth upstream connector C14 are arranged in this order from the -X side toward the +X side.

The optical fibers F extending from the outlet holes 21 and 22 to the outside of the optical wiring component 1 are connected to the first downstream connector C21. The optical fibers F extending from the outlet holes 23 and 24 to the outside of the optical wiring component 1 are connected to the second downstream connector C22. The optical fibers F extending from the outlet holes 25 and 26 to the outside of the optical wiring component 1 are connected to the third downstream connector C23. The optical fibers F extending from the outlet holes 27 and 28 to the outside of the optical wiring component 1 are connected to the fourth downstream connector C24.

The wiring path of the optical fibers F will be described with reference to FIGS. 4 and 1. First, attention is focused on the first upstream connector C11 shown in FIG. 4. A plurality of optical fibers F of the first upstream connector C11 are inserted into the inlet holes 11a to 11h included in the first inlet hole group 11. The optical fibers F inserted into the inlet holes 11a to 11d pass through independent wiring paths inside the optical wiring component 1 and reach the outlet holes 21 to 24, respectively. In addition, these optical fibers F are connected to the first downstream connector C21 and the second downstream connector C22 on the downstream side of the outlet holes 21 to 24. The optical fibers F inserted into the inlet holes 11e to 11h pass through independent wiring paths inside the optical wiring component 1 and reach the outlet holes 25 to 28, respectively. In addition, these optical fibers F are connected to the third downstream connector C23 and the fourth downstream connector C24 on the downstream side of the outlet holes 25 to 28.

Further, the inlet holes 11d, 12d, 13d, and 14d are connected to the outlet hole 21. That is, the optical fibers F included in the four upstream connectors C11 to C14 are connected to one downstream connector C21 through one outlet hole 21. The same applies to the other outlet holes 22 to 28. In this way, the optical wiring component 1 is configured to connect optical fibers F of a plurality of upstream connectors to one downstream connector.

As an example, the optical fibers F constitute a two-core optical fiber ribbon. Eight optical fiber ribbons are connected to the upstream connectors C11 to C14 and the downstream connectors C21 to C24. In this case, a total of 16 optical fibers F are connected to the upstream connectors C11 to C14 and the downstream connectors C21 and C22. In this case, the upstream connectors C11 to C14 and the downstream connectors C21 and C22 may include a 16-core ferrule. In this example, one optical fiber ribbon (that is, two optical fibers F) is inserted into one inlet hole. In addition, four optical fiber ribbons extend from one outlet hole. Eight optical fiber ribbons (that is, a total of 16 optical fibers F) extending from two outlet holes are connected to each of the downstream connectors C21 to C24.

As described above, a plurality of optical fibers F may be inserted into one inlet hole. Alternatively, only one optical fiber F may be inserted into one inlet hole. In addition, the number of optical fibers F connected to the upstream connectors C11 to C14 and the downstream connectors C21 to C24 can be appropriately changed.

As shown in FIG. 1, the wiring path of the optical fibers F provided in the optical wiring component 1 includes a bent portion. Therefore, when the optical fibers F are inserted into the optical wiring component 1, the plurality of optical fibers F are bent along the bent portion of the wiring path. Here, the curvature radius of the bent portion of the wiring path inside the optical wiring component 1 is set to be greater than the allowable bending radius of the optical fibers F. Accordingly, in the optical wiring component 1, the optical fibers F are prevented from being bent at a radius less than the allowable bending radius. In addition, since the wiring path inside the optical wiring component 1 is smoothly bent, the optical fibers F are prevented from getting caught by the bent portion during manufacturing.

Although the optical wiring unit 2 in one or more embodiments includes the upstream connectors C11 to C14 and the downstream connectors C21 to C24, the optical wiring unit 2 may not include such connectors. For example, connectors may not be provided at the time of shipment of the optical wiring unit 2, and the connectors may be attached to the optical fibers F at the installation site of the optical wiring. Alternatively, the connectors may not be connected to the end portions of the optical fibers F in the optical wiring unit 2, but another optical device may be connected thereto.

### Optical Fiber-Wiring Method

Next, an optical fiber-wiring method using the optical wiring component 1 will be described. First, the optical wiring component 1 and a plurality of optical fibers F are prepared. At this point in time, the upstream connectors C11 to C14 may be connected to one end portion of the plurality of optical fibers F. In addition, the optical fibers F may constitute an optical fiber ribbon.

Next, the plurality of optical fibers F are inserted into the optical wiring component 1 from the inlet holes of the inlet hole groups 11 to 14. The plurality of optical fibers F travel downstream along the wiring paths inside the optical wiring component 1. A plurality of joining portions J are provided inside the optical wiring component 1. At these joining portions J, the optical fibers F inserted from the inlet holes of the inlet hole groups 11 to 14 join together. In addition, the outlet holes 21 to 28 are disposed on the downstream sides of the joining portions J. Therefore, the optical fibers F that have joined together at the joining portions J extend from the corresponding outlet holes 21 to 28.

Next, the downstream connectors C21 to C24 are connected to the optical fibers F extending downstream from the outlet holes 21 to 28. In this case, the optical fibers F extending from the outlet holes 21 to 28 may be fusion-spliced to optical fibers provided in advance in the downstream connectors C21 to C24. Alternatively, the optical fibers F extending from the outlet holes 21 to 28 may be assembled to the ferrules of the downstream connectors C21 to C24.

As described above, as shown in FIG. 4, the plurality of upstream connectors C11 to C14 and the plurality of downstream connectors C21 to C24 are connected to each other. In this case, the optical fibers F are naturally three-dimensionally shuffle-wired inside the optical wiring component 1. The shuffle-wiring is a wiring form in which a plurality of optical connectors are connected to one optical connector. The optical fibers F or the optical fiber ribbons may be colored to identify the optical fibers F or the optical fiber ribbons. In this case, it is possible to easily identify which of the upstream connectors C11 to C14 the optical fibers F extending from the outlet holes 21 to 28 belong to. Furthermore, by combining coloring with ring marks or the like, a configuration may be adopted to allow the ordinal number of the optical fibers F or the optical fiber ribbons within a single upstream connector to be identified.

### Optical Wiring Module

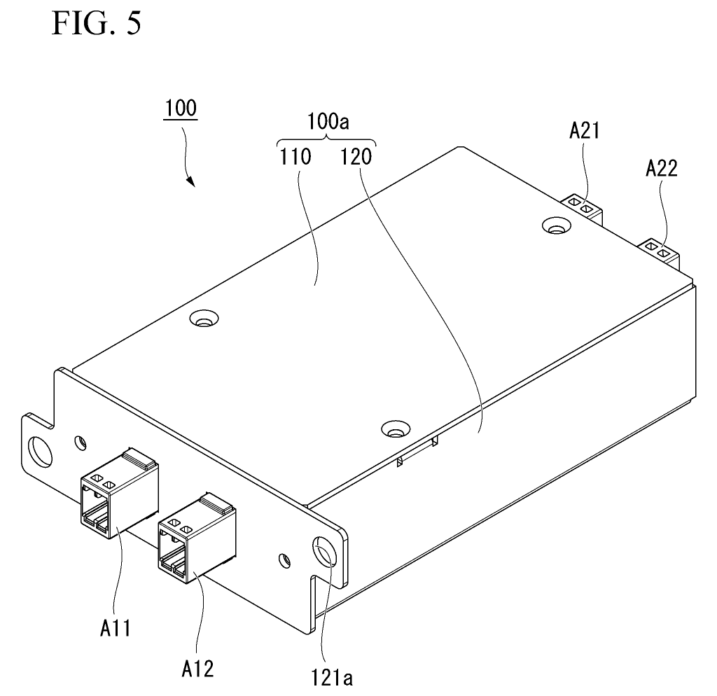

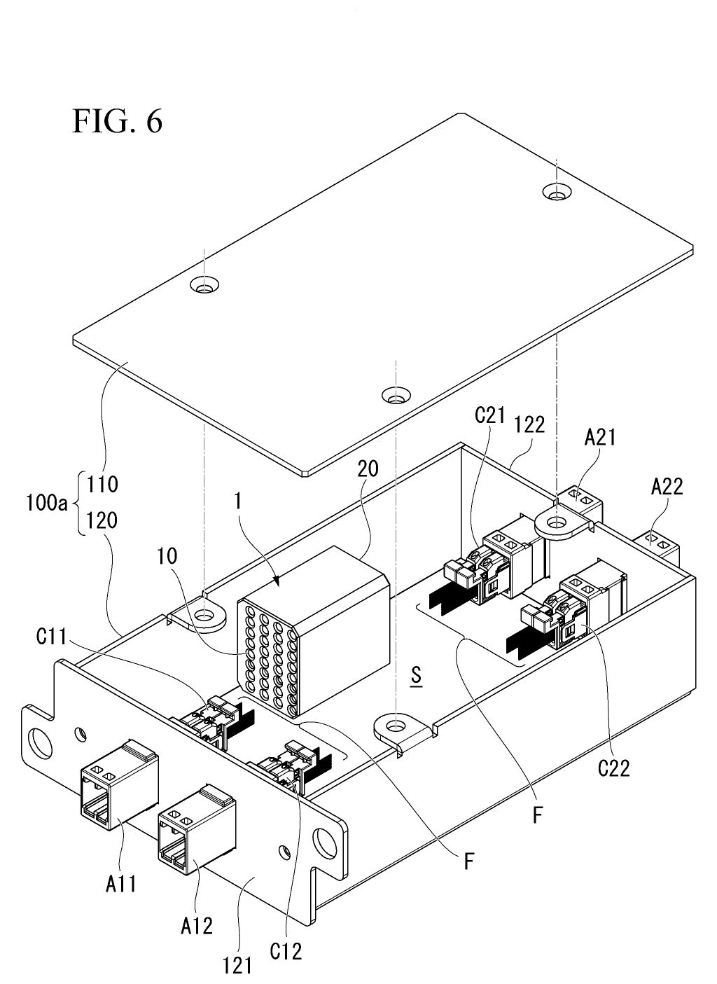

Next, an optical wiring module 100 including the optical wiring component 1 will be described with reference to FIGS. 5 and 6. As shown in FIGS. 5 and 6, the optical wiring module 100 includes a housing 100a, the optical wiring component 1, the plurality of optical fibers F, the upstream connectors C11 and C12, the downstream connectors C21 and C22, upstream adapters A11 and A12, and downstream adapters A21 and A22. In this example, the number of the upstream connectors C11 and C12 and the number of the downstream connectors C21 and C22 are two. However, as shown in FIG. 4 and the like, the number of the upstream connectors and the number of the downstream connectors may be four, or may be three or five or more. The upstream connectors C11 and C12 are connected to the upstream adapters A11 and A12. The downstream connectors C21 and C22 are connected to the downstream adapters A21 and A22.

The optical wiring component 1, the plurality of optical fibers F, the upstream connectors C11 and C12, and the downstream connectors C21 and C22 are accommodated in the housing 100a. In other words, the optical wiring unit 2 is accommodated in the housing 100a. The housing 100a has a rectangular parallelepiped shape as a whole. The housing 100a is composed of two components, that is, a module lid 110 and a module housing body 120. The module housing body 120 has a box shape including an opening, and the opening is closed by the module lid 110. The module lid 110 and the module housing body 120 may be fixed by, for example, screws. By removing the module lid 110, the optical wiring unit 2 accommodated in the module housing body 120 is exposed. However, the configuration of the housing 100a can be appropriately changed.

The module housing body 120 includes an upstream wall 121 and a downstream wall 122. The upstream wall 121 supports the upstream adapters A11 and A12. The downstream wall 122 supports the downstream adapters A21 and A22. A space S that is not occupied by the optical wiring component 1 is provided inside the housing 100a. The space S may be used, for example, to accommodate an extra length portion of the optical fibers F. In FIG. 6, the optical fibers F are partially omitted. In the space S, the extra length portion of the optical fibers F may be wound, for example, in a loop shape.

The optical wiring component 1 is fixed inside the housing 100a. The fixing means is not particularly limited, but for example, screwing, adhesion with an adhesive, or the like can be applied. Similarly, the extra length portion or the like of the optical fibers F may be fixed inside the housing 100a.

According to the optical wiring module 100, the shuffle-wiring portion, the extra length portion, or the like of the optical fibers F can be protected by the housing 100a. Therefore, it is possible to prevent the breaking of the optical fibers F. In addition, as shown in FIG. 5, the housing 100a is provided with a mounting hole 121a for mounting the optical wiring module 100 on a mounting target. The optical wiring module 100 can be easily mounted on the mounting target by using the mounting hole 121a or the like.

### Optical Wiring Device

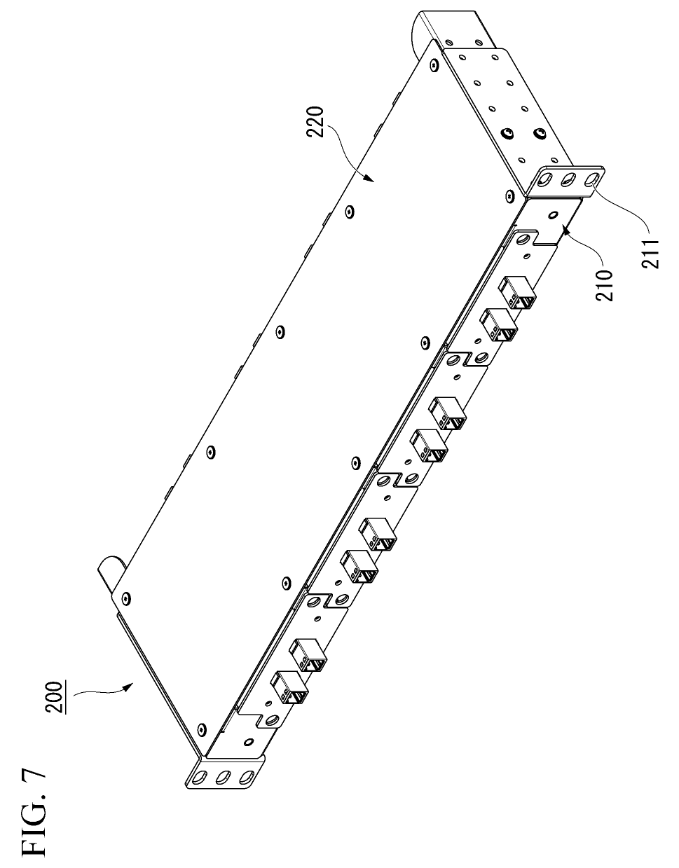

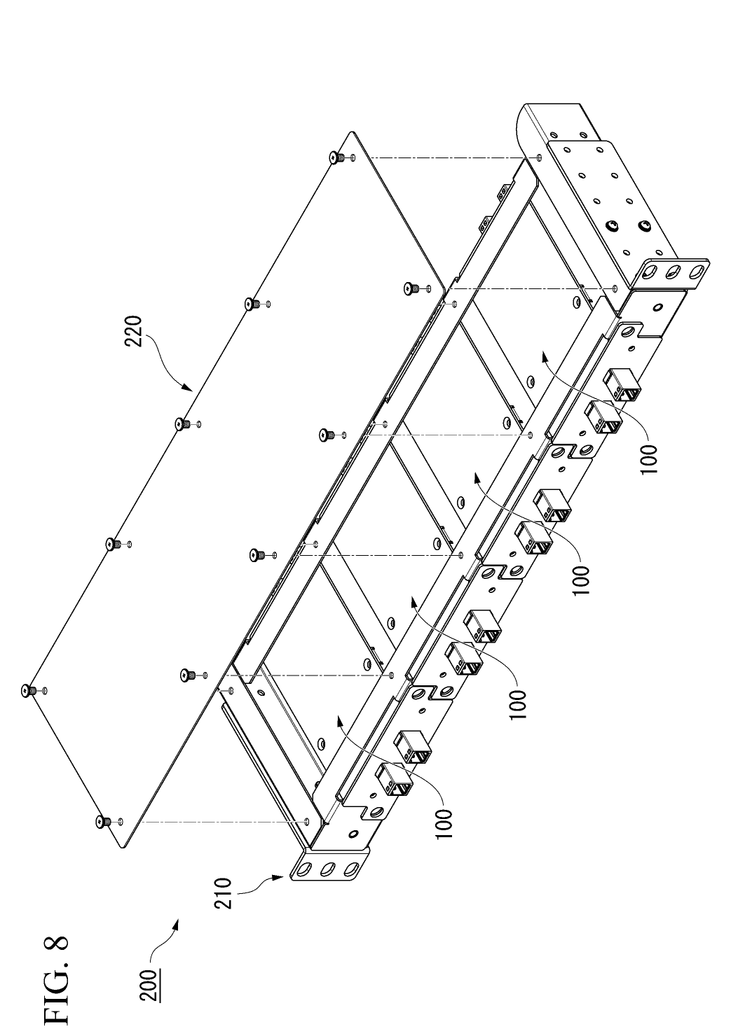

Next, an optical wiring device 200 including the optical wiring module 100 will be described with reference to FIGS. 7 and 8. The optical wiring device 200 includes a device housing 210 and a device lid 220. As shown in FIG. 8, when the device lid 220 is removed, the inside of the device housing 210 is exposed. Four optical wiring modules 100 are accommodated in the device housing 210. The number of optical wiring modules 100 can be appropriately changed.

As shown in FIG. 7, the device housing 210 is provided with a device mounting hole 211 for mounting the optical wiring device 200 on a mounting target. According to the optical wiring device 200, a plurality of optical wiring modules 100 can be easily mounted on the mounting target.

As described above, the optical wiring component 1 of one or more embodiments includes the inlet portion 10 in which the plurality of inlet hole groups 11 to 14 are formed and the outlet portion 20 in which the plurality of outlet holes 21 to 28 are formed. Each of the plurality of inlet hole groups 11 to 14 includes a plurality of inlet holes, and the joining portion J is connected to each of the plurality of outlet holes 21 to 28. The joining portion J is connected to a plurality of inlet holes.

In addition, the optical wiring unit 2 of one or more embodiments includes the optical wiring component 1 and the plurality of optical fibers F inserted from a plurality of inlet holes in the plurality of inlet hole groups 11 to 14 to the plurality of outlet holes 21 to 28.

In addition, an optical fiber-wiring method of one or more embodiments includes a preparation step, an insertion step, a joining step, and an extending step. In the preparation step, the optical wiring component 1 including the plurality of inlet hole groups 11 to 14 and the plurality of outlet holes 21 to 28 and the plurality of optical fibers F are prepared. In the insertion step, the plurality of optical fibers F are inserted into the optical wiring component 1 through a plurality of inlet holes included in each of the plurality of inlet hole groups 11 to 14. In the joining step, the plurality of optical fibers F inserted from the plurality of inlet holes are joined together at the joining portion J inside the optical wiring component 1. In the extending step, the plurality of optical fibers joined at the joining portion J are extended from the outlet hole located on the downstream side of the joining portion J.

According to the optical wiring component 1, the optical wiring unit 2, or the wiring method, the plurality of optical fibers F can be easily shuffle-wired and a wiring state can be maintained by inserting the optical fibers F into the inlet holes included in the inlet hole groups 11 to 14. This makes it possible to alleviate various issues that arise in a case where the wiring state is maintained by bonding a plurality of sheets as in the related art. For example, a case does not occur in which air enters between the sheets and the air expands or contracts due to temperature changes. Therefore, it is possible to prevent lateral pressure from acting on the optical fibers. Alternatively, it is possible to prevent local bending or lateral pressure from acting on the optical fibers pressed by the sheets at a location where the optical fibers intersect with each other. Therefore, it is possible to prevent an increase in transmission loss or breaking in the optical fibers. In addition, even in a case where the wiring is three-dimensionally complicated, the wiring can be realized by inserting the optical fibers F into the inlet holes, which leads to an improvement in the efficiency of manufacturing.

In addition, the curvature radius of the bent portion in the wiring path from the plurality of inlet holes in the plurality of inlet hole groups 11 to 14 to the plurality of outlet holes 21 to 28 may be greater than the allowable bending radius of the plurality of optical fibers F. In this case, it is possible to prevent the optical fibers F from being bent at a radius less than the allowable bending radius inside the optical wiring component 1. Therefore, it is possible to prevent an increase in transmission loss and the like.

In addition, the optical wiring unit 2 may include the plurality of upstream connectors C11 to C14 connected to the plurality of optical fibers F extending upstream from the plurality of inlet holes in the plurality of inlet hole groups 11 to 14, and the plurality of downstream connectors C21 to C24 connected to the plurality of optical fibers F extending downstream from the plurality of outlet holes 21 to 28. In this case, the optical fibers F can be shuffle-wired between the upstream connectors C11 to C14 and the downstream connectors C21 to C24.

In addition, the optical wiring module 100 of one or more embodiments includes the optical wiring unit 2, the plurality of upstream adapters A11 and A12 to which the plurality of upstream connectors C11 and C12 are connected, the plurality of downstream adapters A21 and A22 to which the plurality of downstream connectors C21 and C22 are connected, and the housing 100a that supports the plurality of upstream adapters A11 and A12 and the plurality of downstream adapters A21 and A22. According to the optical wiring module 100, by connecting other optical devices to the upstream adapters A11 and A12 and the downstream adapters A21 and A22, it is possible to easily perform shuffle wiring.

In addition, the optical wiring unit 2 of one or more embodiments includes the block body B including a first end surface serving as the inlet portion 10 and a second end surface serving as the outlet portion 20, and a plurality of tubular wiring paths connecting the plurality of inlet hole groups 11 to 14 and the plurality of outlet holes 21 to 28 are formed inside the block body B. According to this configuration, the optical wiring unit 2 can be easily manufactured. The material of the block body B may be, for example, a resin. In addition, the block body B may be molded by a 3D printer.

In addition, the technical scope of the present disclosure is not limited to the above-described embodiments, and various modifications can be made within the scope of the present disclosure.

For example, in the above-described embodiments, the mounting of the optical wiring module 100 or the optical wiring device 200 on a mounting target has been described using the mounting hole 121a of the optical wiring module 100 or the device mounting hole 211 of the optical wiring device 200. However, the optical wiring component 1 itself may include a mounting hole or the like for mounting on a mounting target. In addition, when the optical wiring unit 2 is used, it does not have to be in the form of the optical wiring module 100 or the optical wiring device 200.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An optical wiring component, comprising:
an inlet portion comprising inlet hole groups, each of the inlet hole groups including inlet holes;
an outlet portion comprising outlet holes; and
a joining portion connected to each of the outlet holes and the inlet holes.

2. An optical wiring unit, comprising:
the optical wiring component according to claim 1; and
optical fibers, each inserted into a respective one of the inlet holes and a respective one of the outlet holes.

3. The optical wiring unit according to claim 2, wherein a curvature radius of a bent portion of each of the optical fibers in a wiring path from the respective one of the inlet holes to the respective one of the outlet holes is greater than an allowable bending radius of that optical fiber.

4. The optical wiring unit according to claim 2, further comprising:
upstream connectors connected to the optical fibers extending from the inlet holes in the inlet hole groups; and
downstream connectors connected to the optical fibers extending from the outlet holes.

5. An optical wiring module, comprising:
the optical wiring unit according to claim 4;
upstream adapters into which the upstream connectors are inserted;
downstream adapters into which the downstream connectors are inserted; and
a housing supporting the upstream adapters and the downstream adapters.

6. The optical wiring component according to claim 1, further comprising:
a block body having:
a first end surface serving as the inlet portion; and
a second end surface serving as the outlet portion, wherein
tubular wiring paths connecting the inlet hole groups and the outlet holes are formed inside the block body.

7. An optical fiber-wiring method, comprising:
preparing:
an optical wiring component including inlet hole groups and outlet holes, and
optical fibers;
inserting the optical fibers into the optical wiring component through inlet holes in each of the inlet hole groups;
joining the optical fibers inserted through the inlet holes at a joining portion inside the optical wiring component; and
extending the optical fibers joined at the joining portion from an outlet hole of the outlet
holes located on a downstream side of the joining portion.
